(19) United States
(12) Patent Application Publication
(10) Pub. No.: US 2024/0228353 A1
(43) Pub. Date: Jul. 11, 2024

(54) WATER DISPENSER FILTRATION SYSTEM WITH PUMP VIBRATION

(71) Applicant: DS Services of America, Inc., Atlanta, GA (US)

(72) Inventor: Bruce D. Burrows, Valencia, CA (US)

(73) Assignee: DS Services of America, Inc., Atlanta, GA (US)

(21) Appl. No.: 18/390,962

(22) Filed: Dec. 20, 2023

Related U.S. Application Data
(60) Provisional application No. 63/476,734, filed on Dec. 22, 2022.

(51) Int. Cl. C02F 9/20

(52) U.S. Cl. CPC C02F 9/20; C02F 1/003

(57) ABSTRACT

A reverse osmosis water filtration system includes an integrated agitation system imparting vibration from a system pump to at least one particulate media filter cartridge. The system may periodically or continually agitate the particulate media of the filter cartridge to disrupt, remove and/prevent channeling and clumping of the particulate media and filtered impurities. The disclosed systems and methods may significantly prolong the usage period of a filter cartridge and increase the efficiency of the filtration system.

### CROSS-REFERENCE TO RELATED APPLICATIONS DATA

This application claims priority to U.S. Provisional Patent Application No. 63/476,734 filed on Dec. 22, 2022, the contents of which is incorporated herein in its entirety.

### FIELD OF THE DISCLOSURE

Aspects of the present disclosure generally relate to water filtration, and more particularly to techniques and apparatuses for water dispenser filtration systems.

### BACKGROUND

Water dispensers are commonplace in offices, restaurants, and other settings. Often, the water dispensers use portable bottles, e.g., five gallon bottles, of water and do not provide water filtration. Instead, the water is filtered prior to storage in the bottle(s). Increasingly, consumers want filtered water and want to monitor water quality and usage. In addition, many consumers that have known bottled water dispensers want to control filtering of the water in their homes and want an alternative to maneuvering high capacity water bottles but want to keep the functionality of their dispenser.

Water filtration removes impurities by reducing water contaminants using a fine physical barrier, a chemical process, or a biological process. Filters may use sieving, adsorption, ion exchanges, among other mechanisms, to remove unwanted substances from water. Unlike a sieve or screen, a filter may potentially remove particles much smaller than the holes through which the water passes.

One disadvantage associated with water purification systems that include reverse osmosis (RO) membranes and/or other types of catalyst pre-filters is that the impurities can concentrate along the RO membranes or the particulate catalyst media can clump together and lead to undesirable channeling. In terms of the RO filter, concentration or accumulation of impurities on the RO membranes results in decreased performance and a shortened service life. Likewise, catalyst particulate media exposed to tap water or relatively unfiltered water for extended durations as a result of channeling will more quickly lose its filtering effectiveness. Traditional filtration systems relied on replacing filter cartridges periodically or when a sensor reading approaches or exceeds a measurable threshold. The clumping and channeling of particulates and impurities in a cartridge may lead to premature replacement of the cartridge.

### SUMMARY

Aspects of the present disclosure provide a reverse osmosis water filtration system including at least one particulate filter and an integrated agitation system that may periodically or continually agitate the particulate media of a filter cartridge to disrupt, remove and/or prevent channeling and clumping of the particulate media and filtered impurities. The disclosed systems and methods may significantly prolong the usage period of a filter cartridge and increase the useful life of the filter(s) and efficiency of the filtration system.

According to one aspect, a system for dispensing filtered water is disclosed. The system may include at least one filter cartridge defining an inlet port and an outlet port. The inlet port may be in fluid communication with a water supply. The at least one filter cartridge may house a particulate filtration medium or catalyst. A pump may be in fluid communication with the water supply and the at least one filter cartridge, the pump delivering fluid under pressure to the filter cartridge. An agitator may be affixed to the pump and coupled to the at least one filter cartridge. The coupling of the agitator to the at least one filter cartridge may allow the transfer of vibration energy from the pump to the particulate catalyst of the at least one filter cartridge.

According to another aspect, a system for dispensing filtered water is disclosed. The system may include at least one filter cartridge defining an inlet port and an outlet port. The inlet port may be in fluid communication with a water supply. The at least one filter cartridge may house a particulate catalyst. A reverse osmosis membrane may be in fluid communication with the outlet port of the at least one filter cartridge. A pump may be in fluid communication with the water supply, at least one filter cartridge and the reverse osmosis membrane. An agitator may be affixed to the pump and coupled to the at least one filter cartridge. The coupling of the agitator to the at least one filter cartridge may allow the transfer of vibration energy from the pump to the particulate catalyst of the at least one filter cartridge. A storage tank may be in fluid communication with the reverse osmosis membrane. A system outlet may be in fluid communication with the reverse osmosis membrane and the storage tank.

The mechanical interface between the pump and the at least one filter cartridge, transferring vibration energy from the pump to the particulate of the at least one filter cartridge, may be a metallic plate bolted to the pump and being in direct abutment relationship to the at least one filter cartridge. When fluid is drawn from the water dispenser the pump is activated to pressurize water for delivery to the at least one filter cartridge. Activation of the pump creates vibration energy. The vibration energy from the pump is translated to a plate attached to the pump. The vibration energy from the plate attached to the pump is translated to the at least one filter cartridge. In this manner, vibration energy is transferred from the pump to the particulates in the at least one filter and channeling of the particulate matter is substantially avoided. The useful life of particulate matter and the at least one filter cartridge is extended and efficiency of the filtration system is enhanced.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description may be had by reference to aspects illustrated in the appended drawings, which are not intended to be limiting of its scope. The same reference numbers in different drawings may identify the same or similar elements.

FIG. 1 shows an exemplary reverse osmosis filtration system, in accordance with aspects of the present disclosure.

FIG. 2 illustrates a particulate catalyst filter cartridge over time, in accordance with aspects of the present disclosure.

FIG. 3 illustrates a logical flow diagram of the transfer of vibration energy from a pump to particulate in the filter cartridge(s), in accordance with aspects of the present disclosure.

### DETAILED DESCRIPTION

The foregoing disclosure provides illustration and description, but is not intended to be exhaustive or to limit the aspects to the precise form disclosed. Modifications and variations may be made in light of the above disclosure or may be acquired from practice of the aspects.

Aspects of the present disclosure include a water filtration system, such as a reverse osmosis filtration system, with an integrated agitator operatively coupled to at least one filtering cartridge. According to one aspect the agitator may be integrated or be part of a pump used to move water through the system. The agitator may cause the redistribution of particulate materials within the cartridge to reduce, remove, or avoid channeling and clumping of the particulate material. Relying on the vibrations or movement of a system pump as an agitator both extends the life of the filtering cartridge and eliminates the need for a separate system component used solely for agitating the cartridges.

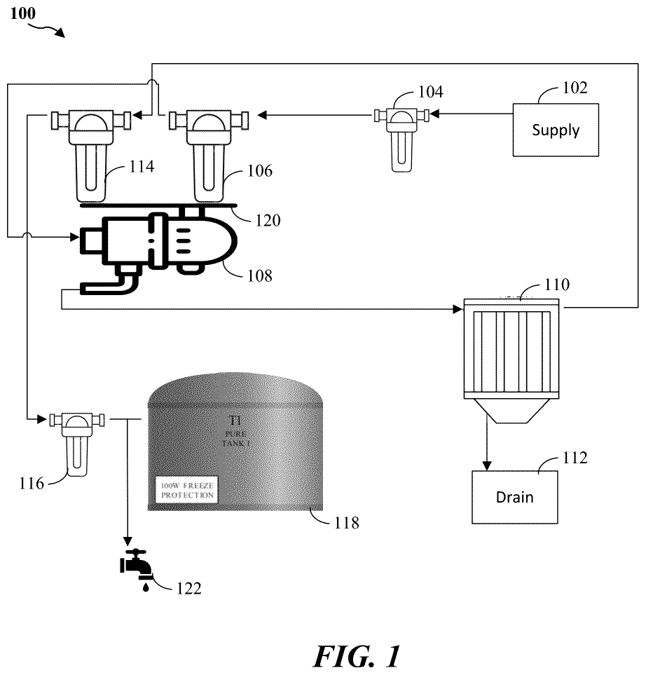

FIG. 1 depicts a reverse osmosis filtration system 100 according to one or more aspects of the present disclosure. The system 100 may include a water supply 102 from which water may be drawn on demand. The water supply 102 may include a water tank, public utility supply, or the like, that supplies contaminated water or water with other undesirable materials such as bacteria, progenies, viruses, pesticides, hydrocarbons, radioactive contaminants, turbidity, colloidal matter, chlorine, detergents, industrial wastes, asbestos, and/or other dissolved solids such as sodium, calcium, magnesium, sulfates and cadmium.

A first filter mechanism 104 may include an inlet port and an outlet port and be in fluid communication with the water supply 102. The first filter 104 may be a filter cartridge housing a particulate catalyst or other filtering material. The first filter mechanism 104 may serve as a sediment filter adapted to reduce particles, such as dirt, dust, rust or other solid sediments from the water supply 102. A second filter 106 may include an inlet port and an outlet port and be in fluid communication with the first filter 104. The second filter 106 may be or include a first-stage carbon filter adapted to reduce volatile organic compounds (VOCs), chlorine and other contaminates. The carbon filter may act to adsorb contaminants as well as act as a catalyst to remove or reduce undesirable materials from the water supply 102. The first and second filters may serve to remove materials that may clog or otherwise disrupt subsequent filtering mechanisms, including a reverse osmosis (RO) membrane 110.

After passing through the first-stage carbon filter, the second filter 106, the water may pass through a pump 108. The pump 108 may pull the water from the supply through the first filter 104 and second filter 106 and push or pressurize the water to a RO membrane 110. The RO membrane may include a polyamide film or other membrane with small perforations, holes, pores, or the like, through which the water may pass but other organic compounds may not pass. The pump 110 may create a high pressure flow of water sufficient to push the water through the RO membrane 110. The RO membrane 110 may be in fluid communication with a drain 112 for dumping contaminants or otherwise removing water from the system.

The RO membrane 110 may also be in fluid communication with a third filter 114, such as a second-stage carbon filter that again acts to adsorb or catalytically remove lingering contaminants. After passing through the second-stage carbon filter, the third filter 114, the water may pass through a fourth filter 116. The fourth filter, like the first filter 102, may serve to remove any lingering contaminants before passing on to a storage tank 118 or a faucet 122 for consumption.

According to one aspect of the present disclosure, the pump 108 may include or form an agitator 120 coupled to the first filter 106 and third filter 114. The agitator, as described herein, may server to disrupt or agitate the particulate catalysts of the first and second stage filters, the second filter 106 and third filter 114. As described herein, as water passes through a filter cartridge, such as those in the second filter 106 and third filter 114, channeling or clumping the particulate material may occur. Applying agitation to the cartridges and the particulate material therein may reduce, remove and avoid such channeling or clumping.

According to one aspect, the pump 108 may include an oscillating motor that drives the pump to push and pull water through the system. The system 100 may leverage the vibrations and movement of the motor and pump to act as the agitation source for the second filter 106 and third filter 114. Advantageously, configuring the pump 108 to provide agitation to the filters makes use of an existing component without the need for a separate agitator or other component, thereby simplifying design and deployment of the system. According to one aspect, the pump 108 may include a plate or other surface forming the agitator 120. The second filter 106 and the third filter 114 may rest on or otherwise abut against the pump plate through which the vibrations of the pump 108 pass into the cartridges of the filters to disrupt and displace the particulate materials. Alternatively, the agitator 120 of the pump 108 may be mechanically coupled, or otherwise affixed to the filter cartridges to allow the transfer of vibrations.

The mechanical interface between the pump and at least one or both of the filter cartridges, transferring vibration energy from the pump to the particulate of the at least one filter cartridge, may be a metallic plate (shown as agitator 120) bolted to the pump. The metallic plate is positioned in direct abutment relationship to the at least one filter cartridge. When fluid is drawn from the water dispenser the pump is activated to pressurize water for delivery to the at least one filter cartridge. Activation of the pump creates vibration energy. The vibration energy from the pump is translated to the plate attached to the pump. The vibration energy from the plate attached to the pump is translated to the at least one filter cartridge. In this manner, vibration energy is transferred from the pump to the particulates in the at least one filter and channeling of the particulate matter is substantially avoided. The useful life of particulate matter and the at least one filter cartridge is extended and efficiency of the filtration system is enhanced.

It should be appreciated that although in the simplest configuration the metallic plate is bolted to the pump and the metallic plate is positioned to directly abut the filter cartridges, other mechanical fasteners may be implemented (e.g., other than bolts), such as straps, rivets, screws, posts, or other mechanical fasteners. Similarly, although the metallic plate as shown is in direct abutment with the filter cartridges, intervening components may be implemented, such as rubber abutments, plastic dampers, or the like (however, the preferred implementation does not require any intervening components). While a metallic plate is preferably implemented, it should be appreciated that other plate materials may be implemented to transfer vibrations from the pump to the filter cartridges.

The system 100 of FIG. 1 depicts a number of filters and components of a reverse osmosis filtration system. For the sake of simplicity, certain components, including valves, sensors, transducers, gauges, meters, and the like have been omitted. It will be appreciated that such components are known in the art and the system 100 may include such components to provide proper and adequate operation of the filtration system. It will also be appreciated that aspects of the present disclosure are not limited to the specific components depicted in FIG. 1. For example, while FIG. 1 depicts four filters and a RO membrane, aspects of the present disclosure may include systems with fewer or additional filters. Further, while the system 100 includes an agitator 120 coupled to the second filter 106 and the third filter 114, aspects of the present disclosure may include supplying agitation to any of the particulate filters in the system, either by energy transfer from pump 108, another pump, or another agitator.

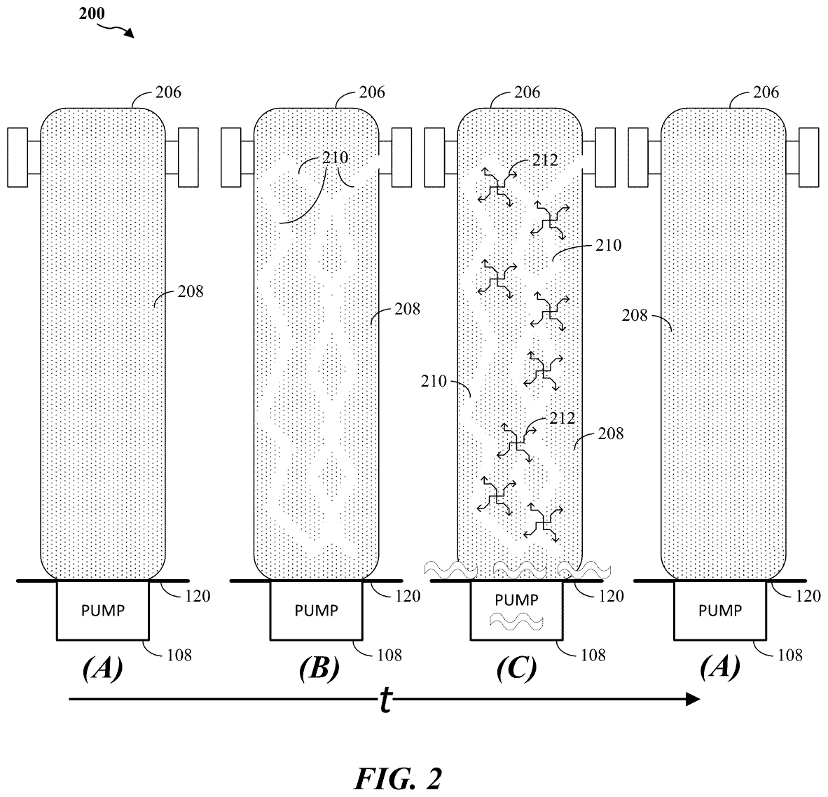

Turning now to FIG. 2, a timeline 200 of a number of filter cartridge states is shown according to one or more aspects of the present disclosure. The timeline reflects the conditions of the filtering material 208, such as a particulate catalyst, within the filter cartridge 206 over a time period, t. As shown, the filter cartridge 206 is coupled to an agitator 120. According to one aspect the agitator 120 is integral with a pump 108 that drives the water through the filtration system. As described herein, the agitator 120, according to one aspect, may include a plate or other surface in mechanical engagement with the pump 120 on which the cartridge may rest against or otherwise be in contact. The plate may be a metallic plate bolted to the pump, and with no intervening components between the metallic plate and the filter cartridge(s). Alternatively, the filter cartridge 206 may be mechanically coupled to the agitator 120.

According to one aspect, at the start of the time period, t, prior to supplying water to the filter cartridge 206 and denoted as state (A), the particulate filtering material 208 is evenly distributed throughout the body of the filter cartridge 206. In this state (A), the particulate filtering material may be the most efficient ensuring substantially all of the water flow through the filter cartridge 206 interacts with the particulate filtering material 208. As time, t, passes, and water flows through the filter cartridge 206, the filtering material 208 may be displaced and begin to form channels 210 or clump, as reflected in state (B). The formation of channels 210 and/or clumps of the particulate filtering material 208 may decrease the amount of water that interacts with the filtering material and may reduce flow of water out of the filter cartridge 206, decreasing efficiency and the lifespan of the filter cartridge 206.

According to aspects of the present disclosure, the filtering material 208 may be periodically disrupted to reduce, remove and avoid the channeling and clumping caused by the water flow. As shown in state (C), according to one aspect, the filter cartridge 206 may be agitated by the agitator 120 integrated with or affixed to the pump 108. The pump 108 may be used to draw water into the system when necessary and push or pull the water through the system. The oscillation of the pump motor and resulting vibration in the motor produces vibration energy 212 that may be transferred through the coupling or contact between the agitator 120 and the filter cartridge 206 to the filtering material 208.

The agitations supplied by the pump 108 through the agitator 120 redistribute the filtering material 208 to remove the channels 210 or clumps. The agitation of the filtering material may return the filter cartridge 206 and filtering material 208 to its initial state (A), and thereby maintained during pumping of the water into and through the filter cartridge, maintaining the efficiency of the filter cartridge 206 and filtering material 208 and extending the usable lifespan of the filter cartridge 206. Sensors throughout the system, not shown, may be relied upon for determining when the pump 108 may be activated to move water through the system. Repeated use of the system may cause the pump to be activated regularly or with sufficient frequency to agitate the filter cartridge 206 such that channeling and clumping of the filtering material is minimized or eliminated. Alternatively, if the pump is not activated by the regular use of the system, a sensor or timer may be used to trigger the activation of the pump 108 and agitate the filter cartridge 206. Water moved through the system that is not a result of demand (i.e., a user opening the faucet to obtain water) may be recycled through the system or passed to the drain.

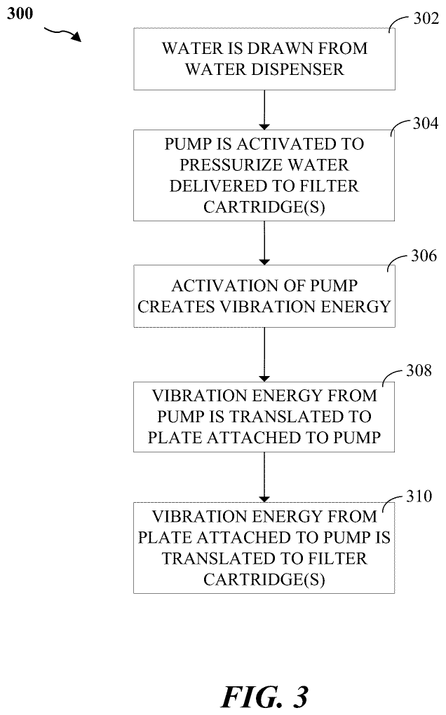

As illustrated in FIG. 3, according to the disclosure water is drawn 302 from the water dispenser. When water is drawn from the water dispenser 302, the pump is activated 304 to pressurize water delivered to the filter cartridges. The activated pump creates vibration energy 306 that is transferred or translated 308 from the pump to the plate attached to the pump. The vibration energy transferred from the pump to the plate is transferred or translated 310 to the filter cartridges against which the plate is positioned in abutment engagement between the plate and the filter cartridges. The vibration energy transferred or translated from the plate to the cartridges is accordingly transferred or translated to the particulate material within the filter cartridges. The vibration of the particulate material reduces or substantially eliminates and clumping or formation of channeling within the particulate material.

In this manner, vibration energy is transferred from the pump to the particulates in the at least one filter and channeling of the particulate matter is substantially avoided. The useful life of particulate matter and the at least one filter cartridge is extended and efficiency of the filtration system is enhanced.

Various aspects of the disclosure are described above, however, such aspects may be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure disclosed, whether implemented independently of or combined with any other aspect of the disclosure. For example, an apparatus may be implemented or a method may be practiced using any number of the aspects set forth. In addition, the scope of the disclosure is intended to cover such an apparatus or method which is practiced using other structure, functionality, or structure and functionality in addition to or other than the various aspects of the disclosure set forth. It should be understood that any aspect of the disclosure disclosed may be embodied by one or more elements of a claim.

It will be apparent that systems and/or methods described may be implemented to include different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code—it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

What is claimed is:

1. A system for dispensing filtered water, comprising:
at least one filter cartridge defining an inlet port and an outlet port, the inlet port in fluid communication with a water supply, the at least one filter cartridge housing a particulate catalyst;
a pump in fluid communication with the water supply and at least one filter cartridge; and
an agitator mechanically engaging the pump and mechanically engaging the at least one filter cartridge, the mechanical engaging of the agitator to the at least one filter cartridge transferring vibration energy from the pump to agitate the particulate catalyst of the at least one filter cartridge.

2. The system of claim 1 further comprising a reverse osmosis membrane in fluid communication with the outlet port of the at least one filter cartridge, the reverse osmosis membrane in fluid communication with the pump.

3. The system of claim 2 further comprising a second filter cartridge disposed between the reverse osmosis membrane and a system outlet, the second filter cartridge coupled to the agitator.

4. The system of claim 1 further comprising a sediment filter disposed between the water supply and the at least one filter cartridge.

5. The system of claim 1 further comprising a sediment filter disposed between the reverse osmosis membrane and a system outlet.

6. The system of claim 1 further comprising a storage tank in fluid communication with the reverse osmosis membrane and a system outlet.

7. The system of claim 1 wherein the particulate material comprises activated carbon.

8. The system of claim 1 wherein the agitator mechanically engaging the pump is a metallic plate affixed to the pump.

9. A water dispenser for dispensing filtered water, comprising:
at least one filter cartridge defining an inlet port and an outlet port, the inlet port in fluid communication with a water supply, the at least one filter cartridge housing a particulate catalyst;
a reverse osmosis membrane in fluid communication with the outlet port of the at least one filter cartridge;
a pump in fluid communication with the water supply, reverse osmosis membrane and the at least one filter cartridge;
an agitator affixed to the pump and coupled to the at least one filter cartridge, the coupling of the agitator to the at least one filter cartridge allowing the transfer of vibration energy from the pump to the particulate catalyst of the at least one filter cartridge;
a storage tank in fluid communication with the reverse osmosis membrane; and
a system outlet in fluid communication with the reverse osmosis membrane and the storage tank.

10. The system of claim 9 wherein the agitator affixed to the pump is a metallic plate affixed to the pump.

11. The system of claim 9 wherein the agitator affixed to the pump is a plate affixed to the pump.

12. The system of claim 9 wherein the agitator affixed to the pump is a plate bolted to the pump.

13. A method for dispensing filtered water from a water dispenser, comprising:
providing at least one filter cartridge defining an inlet port and an outlet port, the inlet port in fluid communication with a water supply, the at least one filter cartridge housing a particulate catalyst;
providing a pump in fluid communication with the water supply and at least one filter cartridge; and
configuring an agitator to mechanically engage the pump and mechanically engage the at least one filter cartridge.

14. The method of claim 13 wherein the mechanical engaging of the agitator to the at least one filter cartridge transfers vibration energy from the pump to agitate the particulate catalyst of the at least one filter cartridge when filtered water is dispensed from the water dispenser.

15. The method of claim 13 further including configuring the pump with a plate as the agitator and wherein the mechanical engaging of the agitator to the at least one filter cartridge transfers vibration energy from the pump to agitate the particulate catalyst of the at least one filter cartridge when filtered water is dispensed from the water dispenser.

16. The method of claim 15 wherein the mechanical engaging of the agitator to the at least one filter cartridge transfers vibration energy from the pump to the plate to agitate the particulate catalyst of the at least one filter cartridge when filtered water is dispensed from the water dispenser.

17. The method of claim 13 further including configuring the pump with a plate as the agitator and disposing the plate into contact with the at least one filter cartridge and wherein mechanical engaging of the agitator into contact with the at least one filter cartridge transfers vibration energy from the pump to the plate and then to the at least one filter cartridge to agitate the particulate catalyst of the at least one filter cartridge when filtered water is dispensed from the water dispenser.

18. The method of claim 17 wherein configuring the pump with a plate as the agitator involves bolting the plate to the pump.

19. The method of claim 17 wherein disposing the plate into contact with the at least one filter cartridge comprises disposing the plate into direct contact with the at least one filter cartridge without any intervening components disposed between the plate and the at least one filter cartridge.

20. The method of claim 13 wherein configuring the agitator to mechanically engage the pump and mechanically engage the at least one filter cartridge comprises disposing a plate as the agitator into direct contact with the at least one filter cartridge without any intervening components disposed between the plate and the at least one filter cartridge.
